(19) United States
(12) Patent Application Publication
(10) Pub. No.: US 2012/0227967 A1
(43) Pub. Date: Sep. 13, 2012

(54) COATED PROPPANTS

(75) Inventors: Humair Shaikh, Sugar Land, TX (US); Syed A. Ali, Sugar Land, TX (US); Mathew Samuel, Sugar Land, TX (US)

(73) Assignee: Schlumberger Technology Corporation, Sugar Land, TX (US)

(21) Appl. No.: 13/044,692

(22) Filed: Mar. 10, 2011

(51) Int. Cl. E21B 43/267; E21B 43/26; C09K 8/80; E21B 43/16

(52) U.S. Cl. 166/280.1; 166/305.1; 507/200; 507/219

(57) ABSTRACT

Particles are provided in which proppant and gravel used in treating subterranean wellbores are coated with most or all of the chemical components needed to make the carrier fluids used to deliver them. The components come off the proppant or gravel during injection and viscosify the fluid. Components may be applied in layers, as uniform or non-uniform mixtures, or both. Particle coatings may include gas pockets that reduce the particle density.

### BACKGROUND

The statements in this section merely provide background information related to the present disclosure and may not constitute prior art.

Some embodiments relate to stimulation of subterranean formations penetrated by wellbores to provide better flowpaths for fluid flow. More specifically, they relate to stimulation methods using proppants and gravel injected in carrier fluids. Most particularly, they relate to proppants and gravel pre-coated with some or all of the components used to prepare the carrier fluids.

Proppants are used extensively in hydraulic fracturing treatments of subterranean formations to keep fractures open and allow for improved fluid flow, for example improved hydrocarbon recovery. Fractures are created by injecting a fracturing fluid viscosified, for example with a polymer, into the subterranean formation through a wellbore at extremely high pressures. After a fracture is initiated, for example with a pad fluid, a slurry of carrier fluid containing proppant is introduced into the fracture. Upon the release of the pressure, the fracture closes and the proppant is trapped in position so that the fracture is kept open to allow fluids, for example hydrocarbons, to flow. Breakers for the polymers are commonly used in the systems to lower the viscosity of the fluid at the end of a fracturing treatment. During flowback of a producing well, the broken fluids containing the polymers come out first, followed by the produced fluids.

In a conventional treatment, a linear (uncrosslinked) or crosslinked polymer fluid is made by mixing polymer and numerous additives in a certain order, typically in a blender, to achieve the desired fluid viscosity. The required concentration of proppant is added to this fluid, typically in a mixer, and pumped downhole into the fracture. Most of these operations are often carried out on the fly.

Most hydraulic fracturing treatments are carried out using sand as the proppant; other hydraulic fracturing treatments use synthetic proppants, for example ceramics, or natural materials such as crushed walnut shells. Proppants are commonly modified with resin coatings to increase crush resistance and/or to make them sticky. The use of resin coated proppants has been known for many years (see U.S. Pat. Nos. 3,659,651; 3,929,191; 5,218,038; 5,422,183; and 5,597,784; incorporated by reference thereto). The resins that are used to coat the proppants include, among others, epoxy resins, furan resins, phenolic resins, phenol-aldehyde resins, and combinations of such resins. The resins may be precured or curable. Significant advances in the area of resins and the resin coating of proppants have been made. Proppants having multiple coatings, for example an inner coating of a curable resin and an outer coating of a cured resin, are discussed in U.S. Pat. No. 7,244,492, incorporated by reference thereto. Resin coatings also help in reducing fines generation from proppants. Hydraulic fracturing with proppants having a deformable core of nut shells, processed wood or plastic, and a deformable coating of a resin is discussed in Patent GB 2,399,118, incorporated by reference thereto.

### SUMMARY

One embodiment is a particle containing components coated on a substrate sufficient to produce a viscous carrier fluid capable of suspending the substrate when the particle is mixed with a base fluid. The substrate is, for example, proppant, gravel or fluid loss additive used in oilfield treatments. The particle is used to make oilfield treatment fluids, for example a coated-proppant particle makes a hydraulic fracturing fluid and a coated-gravel particle makes a gravel packing fluid. The components may be coated on the particle in layers; each component may be in a separate layer or at least one layer may contain more than one component. At least one layer may include at least one region containing at least one additional component, or at least one layer may contain at least two regions including at least one additional component. Further, at least one layer may include at least two regions each containing at least one additional component. Still further, the outer surface of the coated particle and at least one layer may include at least one region containing at least one additional component. Optionally, the first layer applied to the particle may remain on the substrate after formation of the viscous fluid; that first layer may be an adhesive or a resin. More than one layer of the coating may include polymer.

In other embodiments, whether or not the additives are provided in layers, the outer surface of the coated particle may include at least one region containing at least one additional component, or the outer surface of the coated particle may include at least two regions containing at least one additional component, that may be the same or different, or the outer surface of the coated particle may include at least two regions each containing at least one additional component, that may be the same or different.

In yet other embodiments, the particle may also include one or more gas pockets, the particle may further have an outer protective coating containing one or more components not needed to produce a viscous fluid, the components may be adsorbed onto the substrate and/or absorbed in the substrate, and at least one component may be coated onto the particle as a microemulsion.

In additional embodiments, the base fluid may be aqueous and the components include a polymer in an amount sufficient to viscosify the base fluid, for example to a viscosity of at least about 50 cP, or the base fluid may be aqueous and the components include a viscoelastic surfactant in an amount sufficient to viscosify the base fluid, for example to a viscosity of at least about 15 cP, or the base fluid may be a hydrocarbon and the components are present in an amount sufficient to viscosify the base fluid, for example to a viscosity of at least about 50 cP.

Some further embodiments are methods of treating a subterranean formation with a particle suspended in a viscous carrier fluid including the steps of (a) providing a base fluid, (b) providing particles comprising substrate coated with components sufficient to produce a viscous fluid capable of suspending the substrate when the particles are mixed with the base fluid, (c) mixing the base fluid and the particles to form a slurry, (d) injecting the slurry through a wellbore penetrating the subterranean formation, and (e) allowing the particles to release the components and produce a viscous fluid. When the treatment is hydraulic fracturing, the substrate is proppant, the step of injecting is carried out in more than one stage, and the particles in at least one stage are optionally mixed with uncoated proppant. The proportion of coated particles may be varied in different stages. Step (d) may be followed by a step of injecting uncoated proppant.

### BRIEF DESCRIPTION OF THE DRAWING

FIG. 1 shows an example of a coated proppant in which various components are provided in successive layers.

FIG. 2 illustrates an example of a coated proppant containing a gas pocket.

FIG. 3 shows an example of a coated proppant of the Invention in which the various components are not in distinct layers.

### DETAILED DESCRIPTION

Although some of the following discussion emphasizes fracturing with proppant, the coated particles and methods of the Invention may be used in any treatments in which polymer-based additives provide the viscosity to carry solids into subterranean formations, for example fracturing (including slickwater fracturing), gravel packing, and combined fracturing and gravel packing in a single operation. The term “proppant” is intended to include “gravel”. Some embodiments will be described in terms of treatment of vertical wells, but is equally applicable to wells of any orientation. Some embodiments may be described for hydrocarbon production wells, but it is to be understood that the embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

Inventors have discovered certain substrates, such as proppants, gravels, and fluid loss additives, to be injected into a well in a polymer-viscosified aqueous carrier fluid may have a coating of water soluble polymers and other additives that may be used to formulate the carrier fluid from a base fluid. The polymers and additives in the coating dissolve from the substrate surface to the base fluid, for example water or brine, and result in formation of a viscosified fluid. The viscosity assists in the suspension and transport of the proppant, in leakoff control, and in proppant placement. The additives required are coated sequentially, for example in layers, or as uniform or variable mixtures or regions on the proppant to achieve the desired viscosity generation and the desired subsequent fluid break after proppant placement. Alternatively, some of the components may be in discrete layers and some in uniform (homogenous) or non-uniform layers. The gradual dissolution of the coating material in the tubulars may provide the required delay in the crosslinking while pumping.

Other types of stimulation fluids may be made in the same way. For example, components used to make a viscoelastic surfactant (VES) based carrier fluid, or a gelled oil carrier fluid (in which the oil may be, for example, diesel oil, mineral oil, crude oil, condensate, ether, paraffinic oil, frac oil, xylene, toluene, kerosene and mixtures of these materials), may be coated onto suitable substrates. For VES-based fluids, such additives may include the viscoelastic surfactant itself (in either a liquid or solid form) and optionally other additives such as the salts used to make a brine (organic or inorganic), shear recovery additives, breakers, co-surfactants, de-emulsifiers, viscosity enhancers, and others. For gelled oils, the additives may include phosphonates, carboxylates, Al ions or their sources, alkoxides, viscoelastic surfactants, breakers, foamers, and others. The following discussion will be in terms of polymer-based carrier fluids, but it is to be understood that with the appropriate changes in the specific chemicals employed, the discussion is equally applicable to particles that may be used to form VES-based fluids and gelled oil fluids, to methods of making these particles, and to methods of using these particles. Typically, a viscosity of at least about 50 cP is suitable for transporting proppant or gravel; for VES fluids, somewhat lower viscosities, for example about 15 cP, may suffice. When we say a fluid is a carrier fluid, we mean that its viscosity has been increased to at least one of these values, as appropriate, unless the fluid is a foam or an emulsion, both of which may be used as the carrier fluid of the Invention, in which cases the viscosity of the fluid phase may be lower.

The coating material may be formulated for timed release, temperature release, or pressure release of the components. For example, timed release may be by osmosis, the movement of base fluid molecules, for example water, into a higher salt-concentration area in the coating. Temperature may cause dissolution of the coating or make it soft or weak to make it more permeable. The expansion of “gas” (see below) when present inside the particle coating (in low pressure wells) may explode the coating or push additives out.

Any polymer or mixture of polymers that has been used to viscosify oilfield fluids may be used. Non-limiting examples include guar, hydroxypropyl guar, carboxymethyl hydroxypropyl guar, carboxymethyl guar, oxidized guar, polyacrylamide, substituted polyacrylamide, xanthan, diutan, scleroglucan, and hydroxypropyl cellulose, carboxymethylhydroxyethyl cellulose, and polyvinyl alcohol. Polymers incorporated in the coated particle of the Invention may be pre-hydrated, partially hydrated, or non-hydrated.

The viscosifying polymer system may optionally be crosslinked, by incorporating crosslinkers in the coating on the substrate surface. The polymer and crosslinker are not completely leached out or dissolved into the base fluid immediately, but rather over time, so the fluid is not fully crosslinked while it is being pumped downhole. This provides the desired delay in the crosslinking. The crosslinker may be distributed uniformly in the polymer coating. Alternatively, the crosslinker may be distributed non-uniformly. For example, the concentration of crosslinker may gradually or stepwise increase or decrease with increasing depth of the polymer coating. As another example, the crosslinker may be coated onto the substrate first, followed by the polymer. In that case, the polymer is provided to the fluid first, and then the crosslinker. The reverse order may also be used. Of course, crosslinkers may be complex mixtures, such as a combination of a metal and a reducing agent, a combination of a metal and a pH adjuster or buffer, a combination of a metal and a delay agent, a combination of several organic materials, and others. Such multi-component crosslinking systems may be distributed uniformly or non-uniformly in, on or under the polymer layer. The most commonly used crosslinkers used are based on boron, zirconium, titanium or mixtures of these. In another embodiment, the polymer may be crosslinked before it is incorporated in a coated particle.

In another embodiment, particularly suited for polymers, a portion of the viscosifying material is released quickly into the base fluid and a portion is released at later time. This provides a suitable amount of quick and early viscosity generation and then additional viscosification later when it is needed because of, for example, shearing or temperature increase. For example, there may be two or more layers containing polymer; polymer in the two or more layers may be the same or different. As an example an outer layer of the coating may contain a pre-hydrated polymer and an inner layer may contain an unhydrated polymer. Alternatively, an outer layer may contain an inexpensive polymer such as guar and an inner layer may contain a more expensive and more thermally stable polymer such as carboxymethyl hydroxypropyl guar. As another example, an outer layer of polymer may contain less crosslinker than an inner layer of polymer. In each case, the layers of polymer referred to here may be contiguous or may be separated by a layer or layer of coating containing one or more other additives. Many other arrangements may readily be recognized and are within the scope of the Invention.

In the case when all, or nearly all, of the coating components are mixed together before being applied to the substrate, there may be one or more additional materials applied to the outside of the coated particles. These may be one or more components necessary in the preparation of the final viscosified carrier fluid, for example a hydration aid, for example a buffer, or they may be applied for the purpose of protecting the coating until the coated particles are used, for example a rigid or flexible sealant useful to prevent one or more than one of oxidation, water sorption, early viscosification, or non-selective loss of components from the inner coatings. Such coatings may also be used to increase storage time under extreme conditions, for example high humidity, to retain the particle shape, and to prevent the particles from becoming sticky. Such a protective coating may be, for example, a rapidly dissolving resin, for example a phenoxy resin, a wax or a polymer, including terpolymers and thermoplastic elastomers, a latex, a polyester, polyvinyl acetate, a polylactic acid or polyglycolic acid or copolymer of either or both of these, a phenol formaldehyde resin, or compounds made from furfural, bisphenol, melamine, urea, isocyanate, epoxy, or epichlorohydrin. Coupling agents such as silanes (for example N-2-(aminoethyl)-3-aminopropyltrimethoxysilane, 3-glycidoxypropyltrimethoxysilane, and n-beta-(aminoethyl)-gamma-aminopropyltrimethoxysilane) may be used to aid in adhering the coating to the substrate surface. The need for such a coating depends, by non-limiting example, on the temperature and time profiles to be encountered and on the nature of the base fluid.

The first layer applied may remain permanently, or nearly permanently, on the proppant or gravel substrate after the pack is placed. Such a layer may be a layer of adhesive so that the particles stick to each other and minimize flowback. The outer polymer coating is washed or dissolved off, leaving the sticky material behind on the proppant surface. Such a permanent layer may be a resin that is optionally sticky and that improves the proppant strength. The resins that are used to coat the proppants include, among others, epoxy resins, furan resins, phenolic resins, phenol-aldehyde resins, and combinations of such resins. They may be pre-cured or curable resins. In this discussion, when we refer to a coated particle we do not intend the term to refer to a particle coated only with adhesive or resin.

Not all of the components of the carrier fluid, nor all of any single component of the carrier fluid, need be incorporated in the particle coating. For example, if the carrier fluid is a brine, most or all of the salt may be in the water used to make the fluid, for example seawater. Similarly, biocides are typically put in the water to be used before the job, but may be included in the coating as well. If very fast viscosity development is desired, a buffer or pH control agent may be placed in the water; if slower viscosity development is desired, these components may be included in the coating. Furthermore, some fluid components are preferably or only available as liquids, and they may be incorporated in the base fluid.

Other components on or in the coated particle of the Invention include, but are not limited to, polymer-hydrating buffers; carrier fluid buffers; pH adjusters such as caustics and acids; friction reducers; biocides; oxygen scavengers; antioxidants; iron control agents; high temperature polymer and fluid stabilizers; delay additives; fluid loss additives; clay stabilizers; corrosion inhibitors; emulsifiers; demulsifiers; foaming agents; anti-foaming agents; particle transport aids; and proppant flowback control additives. The latter two components may be fibers. Any proppants or gravel may be used including, but not limited to, sand, sized shells, metal, synthetic organic materials, synthetic inorganic materials such as ceramics, and resin coated proppants, including cured and curable resins. Proppants containing binders, fillers, and other additives may be used. Proppants may be light weight, intermediate, or high strength.

The exact distribution of polymer, crosslinker, breaker and other components depends upon the exact choice of these components, on the size and density of the proppant, on features of the job such as the well temperature profile, the pumping schedule, the aqueous fluid pH and salinity, and on other factors related to the fluid, the job, and the formation. One skilled in the art, for example of fracturing, will know how to design the fully coated particles to take into account the chemical choices, the job design, and the well characteristics and conditions. Simple laboratory experiments may be used to optimize the particle coating design for a given situation.

In another variation, the additives are impregnated or absorbed into the substrate. In such cases the substrate is porous, mesoporous, layered, or in some way able to contain the additive materials. The components may also be adsorbed onto the surface of the substrate. The components may be incorporated in the final particle by any combination of impregnation, absorption, adsorption and coating.

Normally, for the suspension of proppants, high fluid viscosity is required. To achieve this viscosity, high concentrations of polymers are used in the industry. Because high polymer concentrations can damage formations and decrease fluid production, the industry trend is to lower polymer concentrations or to use non-damaging surfactant-based fluids. In order to lower polymer concentrations, light weight proppant systems are also used, but light weight proppants typically have lower crush strengths. In another embodiment of the Invention, a polymer coating on the substrate incorporates a trapped gas-pocket. This lowers the density of the entire particle and helps in the suspension of the proppant without compromising the proppant strength. The gas-pocket also allows the operator to achieve proppant suspension in the fluid systems with lower polymer loads and/or with heavier proppants. The resulting buoyancy of the particle and coating with a gas-pocket allows a greater surface area of the polymer coating to interact with the base fluid. This will allow smooth dissolution of the polymer. Individual particles may each have a single gas pocket or may have multiple pockets. The gas may be any gas used in the oilfield, for example to foam or energize fluids, for example air, nitrogen, carbon dioxide, or a hydrocarbon. A vacuum may also be used. Such “gas” pockets may be formed by dipping a dry substrate (optionally uncoated or partially coated) in the gas quickly into a coating solution. The volume of gas is typically less than about 55% of the total volume of the final coated particle. Multiple coatings may be made by spraying, and optionally drying, the product in stages. Any of the layers may incorporate gas pockets.

Depending upon the size and density of the initial substrate, and the required final fluid viscosity, the coated particles have a radius up to about 33% greater (considering the shortest diameter if the substrate is not exactly spherical) than the initial substrate. The weight of the coating is from about 3% to about 25% of the final coated particle. Polymer and coating on the substrate when the material reaches downhole tools and perforations has typically been at least partially removed. Remaining material on the substrate has typically been hydrated and is deformable and slippery. Coated substrate and substrate from which the coating has partially been removed pass through tools and perforations easily.

Coated substrate (for example with polymer and additives) and conventional proppants (whether resin coated or not) may both be used in a job, either sequentially or mixed. For example, coated substrate may be used in the first stage or stages, and then if the proppant loading is increased, uncoated proppant may be used. Alternatively, as the proppant loading is increased, mixtures of coated and uncoated proppant may be used, with the proportion of uncoated proppant remaining constant or increasing. Optionally, the amount of uncoated proppant may be reduced at the end of the job because less viscosity is required at the end of the job due to cool down. The coated particles of the Invention may also be incorporated in a pad fluid or used in slickwater treatments, in which cases they will generally be used at a concentration of less than about 1 ppa (pounds proppant added per gallon) (0.12 kg/L).

The coated particles may also be used as a fluid loss additive, a lost circulation control additive, or a diverting agent. In such cases, the particles may be smaller than conventional proppant or sand, for example may be 100 mesh (150 microns) sand or smaller, or may be other particulates, such as salt crystals, flakes or fibers. Any such material may be the substrate of the coated particles of the Invention.

Coated particles may also be made in which the substrate is a viscosifying polymer, for example guar or a substituted guar. The substrate may be, for example, in the form of freeze-dried polymer pellets or balls, that my optionally be crosslinked. Such coated particles may be used, for example, to generate a pad fluid

Compatibility of components is less of a problem than in conventional jobs; because these are solid systems, interactions between the components of the coating are minimal. Obviously incompatible materials (for example oxidizing and reducing agents, or strong oxidizers and oxygen scavengers) should not be incorporated in the same, or adjacent, layers or coatings. Coated proppants should be monitored for stability, especially during long-term storage under humid conditions. Incompatible additives may be coated onto different proppant portions. For example, polymer and stabilizers may be coated onto one portion of proppant and an oxidizer breaker may be coated onto another portion of proppant. These two proppants may be fed and metered separately during the job, and as the need for breaker varies, more or less of the proppant carrying the breaker may be added. Alternatively, the incompatible additives (or any chosen additives) may be metered in separately rather than being coated onto a substrate.

The method of manufacture of the coated particles depends upon the choices of additives, their amounts, and the order in which they are to be released when they contact the base fluid. In particular, the method of manufacture also depends upon such factors as whether the additives are water-soluble and/or soluble in common solvents; whether they are liquids or solids; if solid, on their melting points; and their miscibility with, or solubility in, each other. Depending upon these factors, additives may be coated onto substrates (or of course onto substrates already coated with other additives), for example, by hot coating (for example hot blending), spin coating, web coating, powder coating, painting, condensation, electrostatic coating, solution deposition, solvent deposition, slurry deposition, dipping, spray coating (for example spray drying), fluid bed coating, V-blending, melt coating, or a combination of these. One skilled in the art will recognize that many methods may be used and many parameters may be adjusted and manipulated to optimize manufacture. Examples include spraying of hydrated or pre-hydrated polymers onto substrates or particles followed by air drying or freeze drying. Foams and emulsions, for example microemulsions containing multiple additives, may be coated onto substrates or particles in a single stage or in multiple stages. Microemulsions of individual additives may be made separately and mixed to form a single fluid without interaction of the multiple components, because there is a phase separating the additives. Microemulsions of various additives may be metered, mixed and deposited onto the proppant, adsorbed onto the proppant, or absorbed into the proppant with little or no interactions. Some experimentation may be required, but is well within the level of skill in the art.

There are a number of advantages to the use of the coated particles of the Invention. Their use minimizes the utilization of mixing and metering equipment at the location, saves time and simplifies rig-up and rig-down, provides consistent gel quality, and lowers friction and helps minimize horse power. The use of low pad volumes, batch-mixed pads, and linear pads may all be practiced to help minimize job complexity and equipment needs.

Some useful embodiments may be further understood from the following examples.

### Example 1

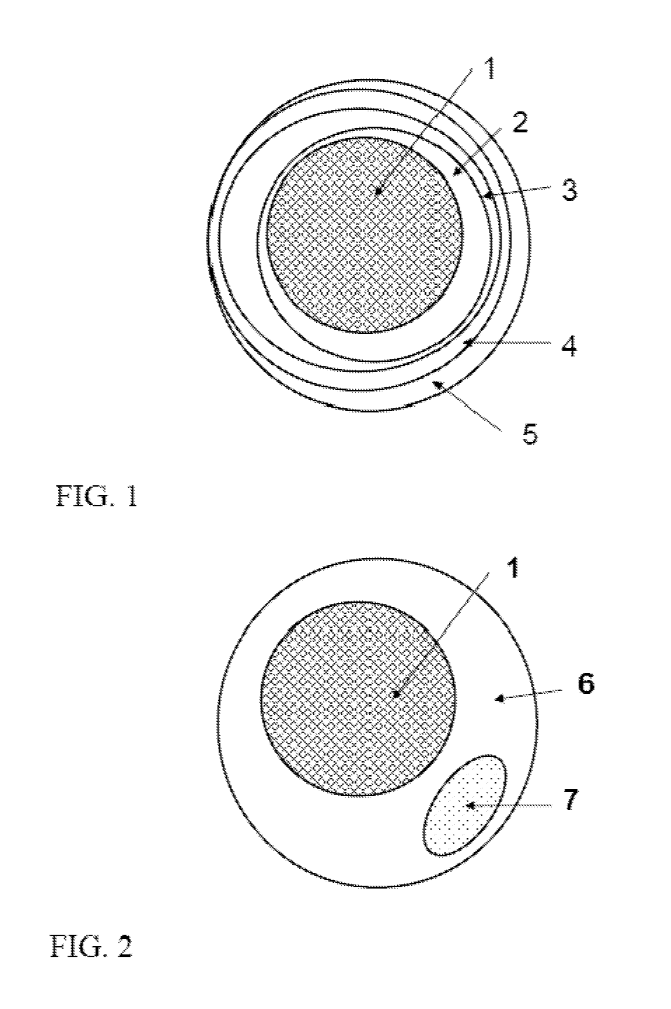

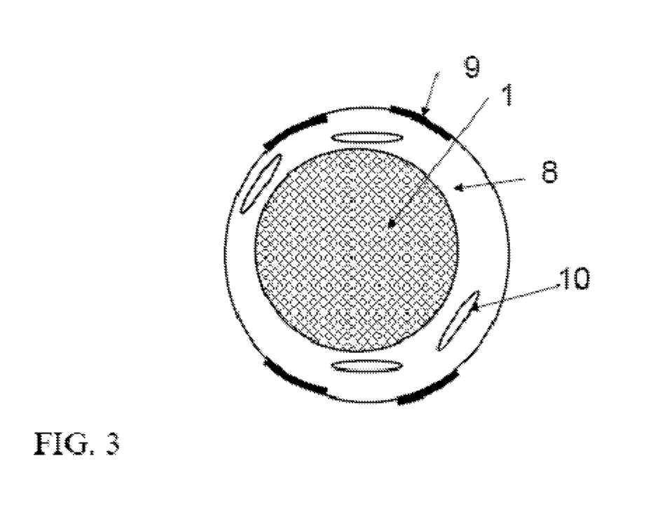

FIGS. 1 through 3 show several examples of coated particles. FIG. 1 shows a proppant substrate [1] coated with successive layers [2-5] of components. Each of these layers may be contain a single component or may include two or more components. It is not necessary that the layers be concentric. The layers are typically of unequal thicknesses. FIG. 2 shows a proppant substrate [1] coated with a single layer of coating [6] containing all the components. The coating further contains a gas pocket [7]. FIG. 3 shows a proppant substrate [1] coated with a layer [8] that contains one or more of the components. There may be more than one such layer, and they may differ in composition. The overall coated particle has on its surface distinct or discrete regions [9] that contain one or more additional components. Layer [8] also contains within it distinct or discrete regions [10] that contain one or more additional components. A particle may contain one or more components as such internal or external regions. Other combinations are of course possible and fall within the scope of the Invention. For example, one or more of the layers [8] may be a single component, and any of the layers in the particles shown in FIGS. 1 and 3 may contain gas pockets. Furthermore, a given component, for example polymer, may be incorporated in more than one layer or more than one region.

### Example 2

Typical additives used to make a liter of representative fracturing fluids useful at different temperatures are shown in Table 1 below.

TABLE 1

| | 35 ppt | | 45 ppt | | 60 ppt | |
|---|---|---|---|---|---|---|
| | (4.2 g/L) | | (5.4 g/L) | | (7.2 g/L) | |
| Temperature | 170° | F. | 280° | F. | 350° | F. |
| | (76.7° | C.) | (137.8° | C.) | (176.7° | C.) |
| KCl | 20 | g | 20 | g | 20 | g |
| Sodium Acetate (100 g in | 1 | ml | 1 | ml | 1 | ml |
| 100 ml aqueous solution) | | | | | | |
| Surfactant (30% Ethoxyl- | 1 | ml | 1 | ml | 1 | ml |
| ated Linear Alcohols | | | | | | |
| in methanol) | | | | | | |
| Sodium Thiosulfate | 2.4 | g | 2.4 | g | 2.4 | g |
| Pentahydrate | | | | | | |
| 50 wt % CMHPG in Diesel | 8 | ml | 10 | ml | 14 | ml |
| Oil | | | | | | |
| Sodium Bicarbonate (6 kg/ | 15 | ml | 15 | ml | 30 | ml |
| 100 L water) | | | | | | |
| Sodium Hydroxide (2 wt % | 12 | ml | 12 | ml | 12 | ml |
| in water) | | | | | | |
| 17 wt % Zr complex in water | 0.6 | ml | 0.6 | ml | 1.2 | ml |
| Sodium Bromate | 0.6 | g | 0.6 | g | 0.6 | g |

In the table, “ppt” is “pounds per thousand gallons” (1 ppt equals 0.12 g/L); CMHPG is carboxymethyl hydroxypropyl guar. In a typical fracturing fluid preparation, 453.6 kg (1000 lbs) of proppant (for example sand or resin coated (precured or curable) proppant) is coated with about 3785 times the amount of each of the additives listed in the table (enough of each additive to make 1000 gallons (3785.4 L) of fluid). This 453.6 kg (1000 lbs) of proppant is mixed with 3785.4 L (1000 gallons) of base fluid (water), and the result is a slurry of 120 kg/1000 L proppant concentration (1 ppa (pounds proppant added per thousand gallons)) in a viscosified fluid. The additives are coated onto the proppant sequentially, for example from the bottom of the table to the top, or some of the additives (for example crosslinker, surfactant, and buffer) are mixed together first and then coated onto the proppant in a single layer. If the intended proppant concentration is less than this, the fluid is diluted further before, or as, it is injected into the well. If the intended proppant concentration is higher than this, uncoated proppant is added. (Optionally, resin coated proppant or proppant coated with another additive may be added.)

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A particle comprising components coated onto a substrate in an amount sufficient to produce a viscous carrier fluid capable of suspending the substrate when the particle is mixed with a base fluid.

2. The particle of claim 1 wherein the components are coated on the substrate in layers.

3. The particle of claim 2 wherein each component is in a separate layer.

4. The particle of claim 2 wherein at least one layer comprises more than one component.

5. The particle of claim 2 wherein at least one layer comprises at least one region comprising at least one additional component.

6. The particle of claim 5 wherein at least one layer comprises at least two regions comprising at least one additional component.

7. The particle of claim 5 wherein at least one layer comprises at least two regions each comprising at least one additional component.

8. The particle of claim 2 wherein the outer surface of the coated particle and at least one layer comprise at least one region comprising at least one additional component.

9. The particle of claim 2 wherein the first layer applied to the substrate remains on the particle after formation of the viscous fluid.

10. The particle of claim 9 wherein the first layer comprises an adhesive.

11. The particle of claim 9 wherein the first layer comprises a resin.

12. The method of claim 2 wherein more than one layer of the coating comprises polymer.

13. The particle of claim 1 wherein the outer surface of the coated particle comprises at least one region comprising at least one additional component.

14. The particle of claim 13 wherein the outer surface of the coated particle comprises at least two regions comprising at least one additional component.

15. The particle of claim 13 wherein the outer surface of the coated particle comprises at least two regions each comprising at least one additional component.

16. The particle of claim 1 further comprising one or more gas pockets.

17. The particle of claim 1 further comprising an outer protective coating comprising one or more components not needed to produce a viscous fluid.

18. The particle of claim 1 wherein the components are adsorbed onto the substrate.

19. The particle of claim 1 wherein the components are absorbed in the substrate.

20. The method of stimulating a subterranean formation, the method comprising: providing an aqueous base fluid and a particle comprising components coated onto a substrate in an amount sufficient to produce a viscous carrier fluid capable of suspending the substrate when the particle is mixed with the base fluid, wherein the components comprise a polymer in an amount sufficient to viscosify the base fluid to a viscosity of at least about 50 cP; and, contacting the subterranean formation with the mixture of the carrier fluid and particle.

21. The method of claim 20 wherein the base fluid is aqueous and the components comprise a viscoelastic surfactant in an amount sufficient to viscosify the base fluid to a viscosity of at least about 15 cP.

22. The method of claim 20 wherein the base fluid is a hydrocarbon and the components are present in an amount sufficient to viscosify the base fluid to a viscosity of at least about 50 cP.

23. The method of claim 20 wherein at least one component is coated onto the particle as a microemulsion.

24. The method of claim 20 wherein the substrate comprises polymer.

25. A method of treating a subterranean formation with a substrate suspended in a viscous carrier fluid comprising (a) providing a base fluid, (b) providing substrate coated with components sufficient to produce a viscous fluid capable of suspending the substrate when the particles are mixed with the base fluid, (c) mixing the base fluid and the particles to form a slurry, (d) injecting the slurry through a wellbore penetrating the subterranean formation, and (e) allowing the particles to release the components and produce a viscous fluid.

26. The method of claim 25 wherein the treatment comprises hydraulic fracturing, the substrate is proppant, the step of injecting is carried out in more than one stage, and the particles in at least one stage are mixed with uncoated proppant.

27. The method of claim 26 wherein the proportion of coated particles is varied in different stages.

28. The method of claim 26 wherein step (d) is followed by a step of injecting uncoated proppant.
